(19) United States
(12) Patent Application Publication
(10) Pub. No.: US 2012/0261953 A1
(43) Pub. Date: Oct. 18, 2012

(54) SUNROOF SEAL MOUNTING ARRANGEMENT AND METHOD

(75) Inventor: Joakim Dryselius, Vaestra Froelunda (SE)

(73) Assignee: VOLVO CAR CORPORATION, Goteborg (SE)

(21) Appl. No.: 13/443,068

(22) Filed: Apr. 10, 2012

(30) Foreign Application Priority Data
Apr. 13, 2011 (EP) 11162247.8

(51) Int. Cl. B60J 10/12; B23P 11/00

(52) U.S. Cl. 296/216.06; 29/428

(57) ABSTRACT

A sunroof for a motor vehicle includes a frame defining a rectangular panel opening and a movable panel. A first flange extends adjacent to at least one edge of the panel opening and is adapted to retain an elongated weather seal in a temporary position in which the seal permits access to the sunroof mechanism necessary to adjust the position of the movable panel during the sunroof installation process. A second flange extends adjacent to and offset from the first flange and is adapted to retain a seal in an installed position in which the seal may restrict access to the sunroof mechanism. The seal is mounted on the first flange prior to installation of the sunroof in the vehicle. Necessary adjustments to the sunroof are made during the installation process, and then the seal is moved on to the second flange after the final installation.

### CROSS-REFERENCE TO RELATED APPLICATIONS

This application claims foreign priority benefits under 35 U.S.C. §119(a)-(d) to EP 11162247.8, filed Apr. 13, 2011, the disclosure of which is incorporated in its entirety by reference herein.

### TECHNICAL FIELD

The invention relates to a sunroof for a motor vehicle. The sunroof comprises a flange for holding a seal, the flange being arranged at least partly on the front, the left and the right side.

### BACKGROUND

An automotive sunroof is a fixed or operable (venting or sliding) opening in an automobile roof which allows light and/or fresh air to enter the passenger compartment. Sunroofs may be manually operated or motor driven, and are available in many shapes, sizes and styles.

Sunroofs, by historical definition, are opaque and slide open to allow sunshine and fresh air into the passenger compartment. Today, most factory sliding sunroofs feature a movable panel and are sometimes marketed as moonroofs. Variations of both the sunroof and moonroof have become the norm in both factory-installed and aftermarket offerings, creating a wide range of features and choices.

Sunroof systems may be manual or electric motor driven. Manual sunroofs may be lever actuated, as in venting type pop-ups, manual lever or crank operated for sliding systems. Electric roof systems are usually cable driven by a motor and feature some form of sliding opening. Most moonroof systems today are electric and have either a combination pop-up/inbuilt or a pop-up/spoiler configuration.

Roof systems may be original equipment, factory installed options (provided by the car company), or installed aftermarket by a roof installation professional for the car dealer or retail customer.

Generally, prior art sunroof assemblies include a weather strip as a sealing member for sealing a clearance between the panel or panels and the roof opening portion in order to prevent the invasion of water and/or to reduce wind noise in a vehicle compartment.

For some presently-used solutions the sealing consists of several parts. In one example there are five different parts; a front acoustic seal, front side covers as well as rear side covers. The front acoustic seal is attached to the main delivery sunroof unit, while the front and rear side covers are separate delivery units. Due to the fully automatic process with the need of access to adjustment screws, the front and rear side covers needs to be assembled manually after the main assembly adjustment process. The parts needs to be picked up from different boxes along the assembly line, brought into the chassis/vehicle and each one assembled onto the sunroof in the interior roof area of the car body.

FIG. 1 is an overview of a sunroof 1 according to prior art. As seals can be seen the front acoustic bulb seal 2, the right front side cover 3 and the right rear side cover 4. With the left side front and rear side covers this thus results in five different parts. A partial cross section at the front side cover 3 can be seen in FIG. 2. An adjustment mechanism 5 is on the inside of the front side cover 3, i.e. the front side cover 3 can only be mounted after the glass panel 6 has been adjusted into its final position by the adjustment screw 5. A headlining 7 is finally covering the carrying structure of the sunroof 1.

### SUMMARY

In a first embodiment disclosed herein, a sunroof for a motor vehicle comprises a frame defining a rectangular panel opening and a movable panel. A first flange extends adjacent to an edge of the panel opening and is adapted to retain a seal in a temporary position prior to final installation of the sunroof in the vehicle, and a second flange extends adjacent to and offset from the first flange and is adapted to retain a seal in an installed position. The seal may be mounted on the first flange prior to installation of the sunroof in the vehicle then moved on to the second flange after the final installation of the sunroof in the vehicle.

In another embodiment, a method for installing a sunroof in a roof opening of a vehicle comprises mounting a seal on a first flange of the sunroof, placing the sunroof in the roof opening, adjusting a position of a panel of the sunroof, and moving the seal from the first flange to a second flange. The first and second flanges extend along at least one edge of a panel opening and are offset from one another. The first flange is positioned so that when the seal is mounted to it the seal permits access to an apparatus used to adjust the panel position, and the second flange is positioned so that when the seal is mounted to it the seal at least partially restricts access to the adjustment apparatus.

### BRIEF DESCRIPTION OF THE DRAWINGS

The present invention will hereinafter be further explained by means of non-limiting examples with reference to the appended drawings wherein:

FIG. 1 shows a prior art a sunroof system;

FIG. 2 is a cross section of a part of the sunroof system in FIG. 1;

FIG. 3 is a cross section of a part of a sunroof system with a seal in a temporary position;

FIG. 4 is a cross section of a part of the sunroof system with a seal in its final position; and

FIG. 5 is a perspective view of a sunroof system with the alternative temporary and final positions of the seal indicated on one of the sides.

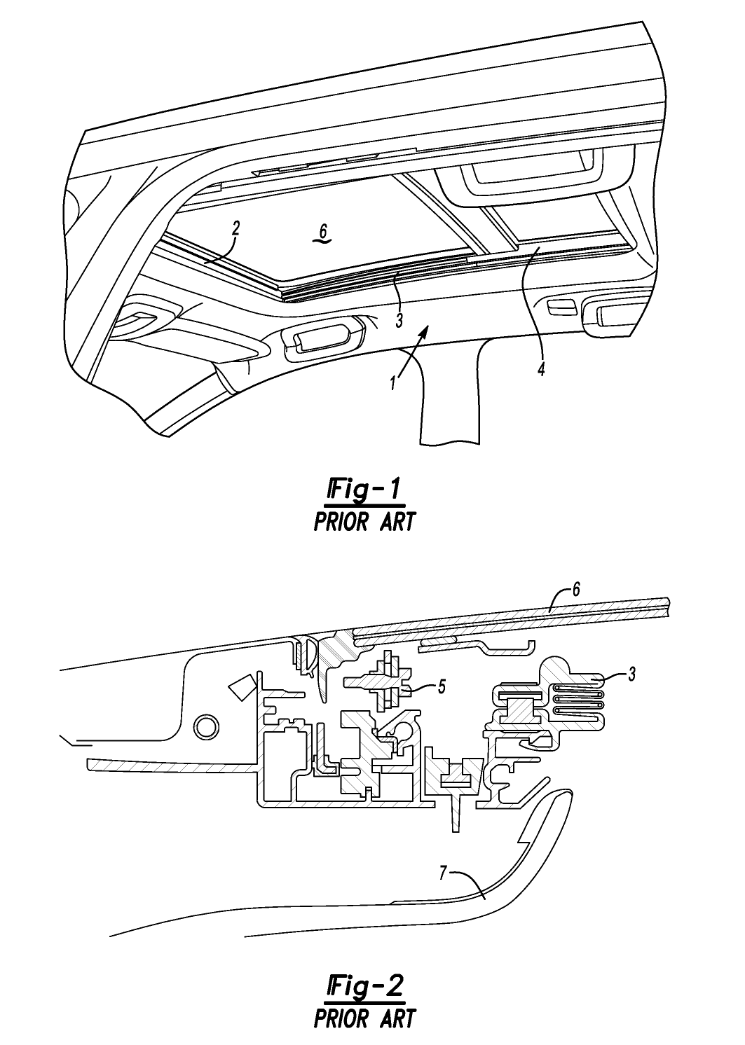

### DETAILED DESCRIPTION

The invention will, in the following, be exemplified by embodiments. It should however be realized that the embodiments are included in order to explain principles of the invention and not to limit the scope of the invention, defined by the appended claims. Details from two or more of the embodiments may be combined with each other.

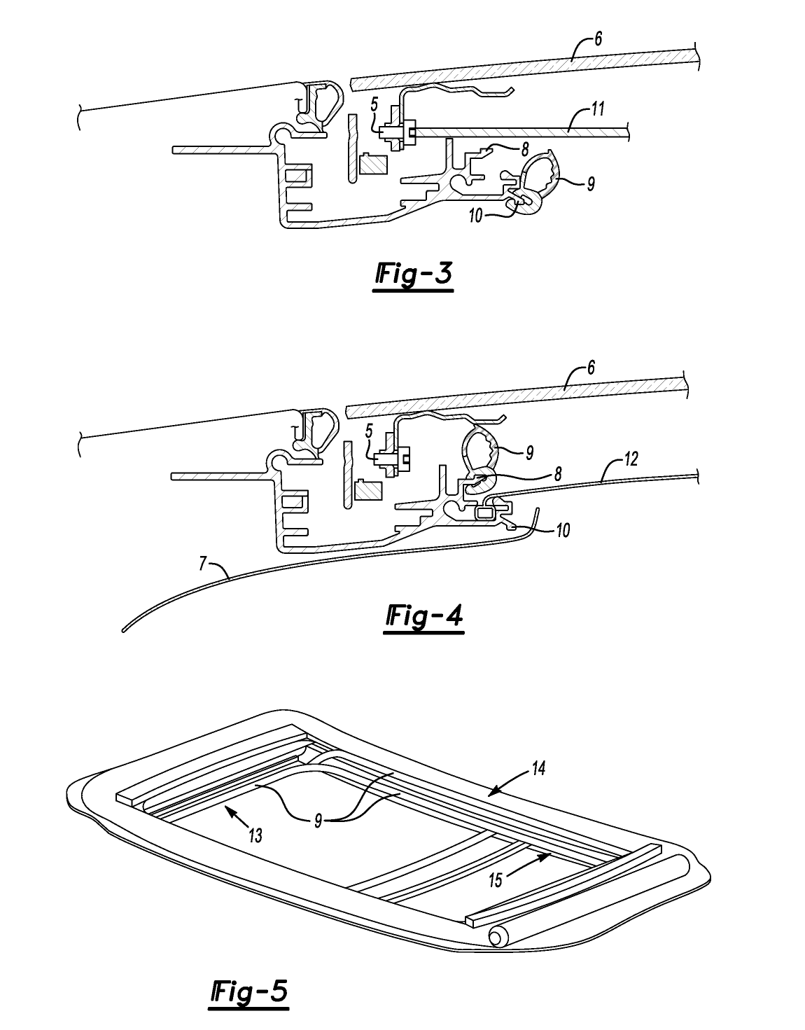

FIG. 3 is a cross section of a sunroof installed in a vehicle, a portion of the roof of the vehicle generally indicated at 20. The sunroof defines a generally rectangular frame defining a panel comprising a front edge, a rear edge, a left side edge and a right side edge.

The sunroof comprises a flange 10 extending along at least a portion of the left and the right side edges for holding an elongated seal 9, such as a bulb seal, when the sunroof is being installed in the opening in the vehicle roof. The cross section in FIG. 3 is from one of the sides of the sunroof and shows an adjustment mechanism 5 (such as a screw) being turned by a screwdriver 11 or other tool having a similar function for adjusting the position of a movable panel 6. In FIG. 3, the seal 9 is in the temporary or “parking” position mounted on the flange 10 thus enabling the screwdriver 11 to pass through a space above the seal to reach the adjustment mechanism 5.

The sunroof further comprises a flange 8 adapted to hold the seal 9. The flange 8 may extend along at least portions of the front edge, the left side edge, and the right side edge of the sunroof opening. In FIG. 4 the seal 9 is shown mounted on flange 8 in its final installed position. A headlining 7 is shown along with a roller blind 12 in a closed position. As seen in FIG. 4, the temporary mounting flange 10 may be hidden from view of an installer or other occupant positioned inside the vehicle after the headlining 7 has been mounted.

The flanges 8 and 10 may be formed as integral parts of an extrusion that serves as the frame of the sunroof. Apart from the fact that aluminium is light, extruded aluminium profiles are generally already present in the structure for holding and controlling the movement of the panels. Thus, the temporary seal position flange could in its simplest form be a lip protruding from the already “existing” aluminium profile.

In FIG. 5 the lower side of the sunroof is shown. Seal 9 is schematically indicated extending along on the forward edge 13, and along the left side edge in both of the two alternative positions: the parked position 14 and the installed position 15. Seal 9 is shown in only the final installed position along the forward edge 13, as may be the case if there is no need to access an adjustment device or other component or device adjacent to the forward edge 13 to which access is required during the installation process. In such a case, the seal 9 may be attached to a flange along the forward edge 13 in its final installed position prior to installation of the sunroof.

The seal 9 is first installed in the parked position 14 on the flange 10 to provide access as necessary to allow adjustments to be made to the position of panel 6. The seal may be mounted in the parked position 14 at a place of manufacture of the sunroof and the sunroof, and then shipped to a final vehicle assembly plant. The sunroof can then be mounted in the roof opening of the vehicle. When in the parked position, the seal is already attached to the sunroof and all parts necessary are conveniently available for the assembly personnel.

After the position of the movable panel 6 has been properly adjusted using, for example screwdriver 11, the seal 9 is easily moved from the temporary seal position flange 10 to the final installed position flange 8 in those locations where the temporary seal position flange 10 is present, i.e., in this depicted example, on the left side of the sunroof.

As best seen in FIGS. 3 and 4, the temporary seal position flange 10 is arranged at a distance from the movable panel 6 that is greater than the distance between the installed position flange 9 and the movable panel. The temporary seal position flange 10 may be located on the same side of the structure as the installed position flange, i.e. on the outer periphery. However, it could be an option to have the temporary seal position flange arranged on the inside of the structure/periphery, thus making it easier to detect whether or not the seal has been placed in its final position.

Thus, with the disclosed apparatus and method one part replaces five parts present in the prior art sunroof arrangement. The one part being a combined acoustic/inner blind seal, temporarily fixed to the sunroof structure in a “parking” position on said temporary seal position flange during transport. These parking position flanges are adjacent to where the adjustment screws/devices are located, i.e. when the bulb is parked the adjustment screws/devices are accessible.

Further advantages are reduction in number of parts which leads to cost savings, man hour savings at production line as well as improved ergonomics for assembly personnel.

The foregoing is a disclosure of an example practicing the present invention. However, it is apparent that method incorporating modifications and variations will be obvious to one skilled in the art. Inasmuch as the foregoing disclosure is intended to enable one skilled in the art to practice the instant invention, it should not be construed to be limited thereby, but should be construed to include such modifications and variations as fall within the scope of the claims.

For instance, the temporary seal position flange could be arranged as desired on all four sides or three of the sides. A further possibility is to have some kind of indicator that clearly shows if the seal is in its final position or if it is in the parking position, i.e. for facilitating for the assembler to know whether or not that part of assembling is complete.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A sunroof for a motor vehicle having a movable panel and a rectangular panel opening and comprising:
a first flange extending adjacent to an edge of the panel opening and adapted to retain a seal in a temporary position prior to final installation of the sunroof in the vehicle; and
a second flange offset from the first flange and adapted to retain a seal in an installed position.

2. The sunroof according to claim 1 wherein the first and second flanges are parallel with one another.

3. The sunroof according to claim 1 wherein the first and second flanges are portions of an extrusion.

4. The sunroof according to claim 1 wherein the second flange extends along three sides of the panel opening.

5. The sunroof according to claim 1 wherein the first flange is disposed at a first distance from the movable panel greater than a second distance between the second flange and the movable panel.

6. The sunroof according to claim 1 further comprising a position adjustment device adjacent the edge of the panel opening along which the seal extends.

7. The sunroof according to claim 1 wherein the second flange is disposed along a left side edge and a right side edge of the opening.

8. A method for installing a sunroof in a roof opening of a vehicle, comprising:
mounting a seal on a first flange of the sunroof, the first flange extending along an edge of a panel opening defined by the sunroof;
placing the sunroof in the roof opening;
adjusting a position of a movable panel of the sunroof; and
moving the seal from the first flange to a second flange extending along the edge of the panel opening and offset from the first flange.

9. The method according to claim 8 wherein the first and second flanges are parallel with one another.

10. The method according to claim 8 wherein the first and second flanges are portions of an extrusion.

11. The method according to claim 8 wherein the second flange extends along three sides of the panel opening.

12. The method according to claim 8 wherein the first flange is disposed at a first distance from the movable panel greater than a second distance between the second flange and the movable panel.

13. The method according to claim 8 wherein the second flange is disposed along a left side edge and a right side edge of the opening.

14. The method according to claim 8 wherein step of adjusting the position of the panel comprises inserting a screwdriver into a space between the second flange and the panel.

15. A method for installing a sunroof in a roof opening of a vehicle, comprising:
manufacturing a sunroof having a movable panel, a panel position adjustment mechanism, and an extrusion extending along an edge of a panel opening defined by the sunroof, the extrusion comprising a first flange disposed a first distance from a movable panel and a second flange paralleling the first flange and disposed a second distance from the movable panel, the first distance greater than the second distance;
mounting a seal on the first flange in a position in which the seal allows access to the panel position adjustment mechanism;
installing the sunroof in the roof opening;
operating the panel position adjustment mechanism; and
moving the seal from the first flange to the second flange, the seal when mounted on the second flange being positioned to restrict access to the panel position adjustment mechanism.

16. The method according to claim 15 wherein step of adjusting the position of the panel comprises inserting a screwdriver into a space between the second flange and the panel.

17. The method according to claim 15 further comprising installing a headlining adjacent to the extrusion to hide the first flange from viewing by an occupant of the vehicle.
